(19) United States
(12) Patent Application Publication
(10) Pub. No.: US 2008/0096571 A1
(43) Pub. Date: Apr. 24, 2008

(54) Method, apparatus, network element and software product for shared channel allocation based on occurrence of hybrid automatic repeat request retransmissions

(76) Inventors: Klaus I. Pedersen, Aalborg (DK); Frank Frederiksen, Klarup (DK); Troels Kolding, Klarup (DK)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/728,974

(22) Filed: Mar. 26, 2007

Related U.S. Application Data
(60) Provisional application No. 60/785,682, filed on Mar. 24, 2006.

(51) Int. Cl. H04Q 7/20

(52) U.S. Cl. 455/450

(57) ABSTRACT

The invention provides a method or system where the network element (NE) sends an allocation to the user equipment (UE) based on whether a HARQ retransmission is expected. For example, if a HARQ retransmission is expected, then the UE can reduce the information contained in the allocation so as to send less (or no) bits in the downlink.

### CROSS-REFERENCE TO RELATED APPLICATION

The present application claims priority to U.S. Provisional Application No. 60/785,682 filed Mar. 24, 2006.

### FIELD OF THE INVENTION

The present invention relates to wireless communication, and more particularly to the downlink control channel carrying user allocation information.

### BACKGROUND OF THE INVENTION

LTE, or Long Term Evolution, is a name for research and development involving the Third Generation Partnership Project (3GPP), to identify technologies and capabilities that can improve systems such as the Universal Mobile Telecommunications System (UMTS) Terrestrial Radio Access Network (UTRAN) or long term evolutions of UTRAN UMTS. As can be seen in FIG. 1a, the UMTS architecture consists of user equipment 102 (UE), the UMTS Terrestrial Radio Access Network 104 (UTRAN), and the Core Network 126 (CN). The air interface between the UTRAN and the UE is called Uu, and the interface between the UTRAN and the Core Network is called Iu.

The UTRAN consists of a set of Radio Network Subsystems 128 (RNS), each of which has geographic coverage of a number of cells 110 (C), as can be seen in FIG. 1a. The interface between the subsystems is called lur.

Each Radio Network Subsystem 128 (RNS) includes a Radio Network Controller 112 (RNC) and at least one Node B 114, each Node B having geographic coverage of at least one cell 110. As can be seen from FIG. 1, the interface between an RNC 112 and a Node B 114 is called lub, and the lub is hard-wired rather than being an air interface. For any Node B 114 there is only one RNC 112. A Node B 114 is responsible for radio transmission and reception to and from the UE 102 (Node B antennas can typically be seen atop towers or preferably at less visible locations). The RNC 112 has overall control of the logical resources of each Node B 114 within the RNS 128, and the RNC 112 is also responsible for handover decisions which entail switching a call from one cell to another or between radio channels in the same cell.

LTE, or Long Term Evolution (also known as 3.9G), refers to research and development involving the Third Generation Partnership Project (3GPP) aimed at identifying technologies and capabilities that can improve systems such as the UMTS. The present invention is related to LTE work that is taking place in 3GPP.

Generally speaking, a prefix of the letter “E” in upper or lower case signifies LTE, although this rule may have exceptions. The E-UTRAN consists of eNBs (E-UTRAN Node B), providing the E-UTRA user plane (RLC/MAC/PHY) and control plane (RRC) protocol terminations towards the UE. The eNBs interface to the access gateway (aGW) via the SI, and are inter-connected via the X2.

An example of the E-UTRAN architecture is illustrated in FIG. 1b. This example of E-UTRAN consists of eNBs, providing the E-UTRA user plane (RLC/MAC/PHY) and control plane (RRC) protocol terminations towards the UE. The eNBs are interconnected with each other by means of the X2 interface. The eNBs are also connected by means of the SI interface to the EPC (evolved packet core) more specifically to the MME (mobility management entity) and the UPE (user plane entity). The Si interface supports a many-to-many relation between MMEs/UPEs and eNBs. The SI interface supports a functional split between the MME and the UPE. The MMU/UPE in the example of FIG. 2 is one option for the access gateway (aGW).

In the example of FIG. 1b, there exists an X2 interface between the eNBs that need to communicate with each other. For exceptional cases (e.g. inter-PLMN handover), LTE_ACTIVE inter-eNB mobility is supported by means of MME/UPE relocation via the SI interface.

The eNB may host functions such as radio resource management (radio bearer control, radio admission control, connection mobility control, dynamic allocation of resources to UEs in both uplink and downlink), selection of a mobility management entity (MME) at UE attachment, routing of user plane data towards the user plane entity (UPE), scheduling and transmission of paging messages (originated from the MME), scheduling and transmission of broadcast information (originated from the MME or O&M), and measurement and measurement reporting configuration for mobility and scheduling. The MME/UPE may host functions such as the following: distribution of paging messages to the eNBs, security control, IP header compression and encryption of user data streams; termination of U-plane packets for paging reasons; switching of U-plane for support of UE mobility, idle state mobility control, SAE bearer control, and ciphering and integrity protection of NAS signaling.

The present invention is related to LTE. However, the solution of the present invention may also be applicable to present and future systems other than LTE.

A current working assumption for LTE is that users are explicitly scheduled on a shared channel every transmission time interval (TTI) by the serving Node B. A Node B is the UMTS counterpart to the term “base station” in the Global System for Mobile Communication (GSM).

In order to facilitate the scheduling on the shared channel, the Node-B transmits an allocation in a downlink shared control channel to the user equipment (UE). The allocation information will often be related to both uplink and downlink. The functionality of the allocation is in principle similar to the high speed shared control channel (HS-SCCH), which is used for high speed downlink packet access (HSDPA).

The allocation is used to signal which user(s) are going to be scheduled in each TTI. The current default assumption in 3GPP is that the allocation includes information about which resource blocks in the frequency domain are allocated to scheduled user(s), which modulation scheme to use, what the transport block size is, and the like. The allocation also often includes various information related to hybrid automatic repeat requests (HARQ). Detailed information about HARQ can be found in 3GPP TR 25.814, Physical Layer Aspects for Evolved UTRA (Release 7), Version 1.2.1 (2006-2), which is hereby incorporated by reference in its entirety.

As mentioned, an allocation often includes information related to hybrid automatic repeat requests (HARQ). It is known to use HARQ as an HSDPA feature which causes a Node B to retransmit a data packet when the first transmission is not successful. A HARQ process often comprises several packet transmissions and retransmissions. The various forms of HARQ schemes can be classified as adaptive or non-adaptive in terms of transmission attributes such as the Resource Block (RB) allocation, Modulation and transport block size, and duration of retransmission. Adaptive HARQ implies the transmitter may change some or all of the transmission attributes used in each retransmission as compared to the initial transmissions (e.g. due to changes in the radio conditions). Hence, the associated control information needs to be transmitted with the retransmission. The changes may include Modulation, Resource Block allocation, and Duration of transmission. In contrast, Non-Adaptive HARQ implies that changes, if any, in the transmission attributes for the retransmissions, are known to both the transmitter and receiver at the time of the initial transmission. Hence, the associated control information need not be transmitted for the retransmission.

HARQ can also be classified as being synchronous or asynchronous. Synchronous HARQ implies that (re)transmissions for a certain HARQ process are restricted to occur at known time instants. No explicit signaling of the HARQ process number is required as the process number can be derived from, for example, the sub-frame number. In contrast, asynchronous HARQ implies that (re)transmissions for a certain HARQ process may occur at any time. Explicit signaling of the HARQ process number is therefore required.

Because the allocation often requires an undesirable amount of signalling overhead, it is a design goal in 3GPP to minimize the number of bits used for the AT. That would allow more bits to be used to provide other benefits.

### SUMMARY OF THE INVENTION

The number of bits required by the allocation can be reduced by recognizing that less signaling information is required in the allocation for cases where HARQ retransmissions are scheduled as compared to cases where first transmissions are scheduled. Because some parameters are common for first transmissions and retransmissions, less transmission information is needed for HARQ retransmissions, depending upon the selected HARQ scheme.

Therefore, the present invention defines at least two formats of the AT: one format for scheduling a first transmission, and one format for scheduling a HARQ retransmission. The allocation can be made smaller for cases where HARQ retransmissions are scheduled.

Reducing the allocation in case of HARQ retransmissions reduces the signaling overhead for HARQ retransmissions, while still achieving the full system gain of HARQ. Thus, the invention is characterized by initiating an allocation in order to schedule users for a shared channel, and including less transmission information in the allocation for a scheduled HARQ retransmission than for a scheduled first transmission. This impacts the design of both the user terminal and the base station (i.e. Node B) design in the LTE, while helping to achieve 3GPP design goals.

The method, apparatus, user equipment (UE), system, network element, and software product of the present invention facilitate allocation of a shared channel by making the allocation dependent upon whether HARQ retransmissions occur. This allocation can be further improved by taking into consideration the type of HARQ retransmission that occurs.

The method or system of the invention may include one or more steps or elements for implementing this functionality in the network element (NE). In particular, embodiments according to the present invention may include the NE having a module for sending the allocation based on whether a HARQ retransmission is expected. The module may include one or more steps for determining when the HARQ retransmissions are scheduled. User equipment (UE) may also be adapted for accepting the allocation.

The present invention may also take the form of a chipset for the UE or NE, in order to carry out the aforementioned functionality, as well as a computer program product with a program code, which program code is stored on a machine readable carrier, for carrying out the steps of the method according to the present invention. The method may also feature implementing the steps of the method via a computer program running in a processor, controller or other suitable module in the UE or NE in the network.

The scope of the invention is intended to include implementation in a UMTS packet network such as (but not limited to) that shown in FIGS. 1a, 1b; UTRAN long term evolution (LTE) in the third generation partnership project (3GPP), including the specifications set forth in 3GPP TR 25.814 as they relate to the “Evolved UTRA and UTRAN;” as well as other suitable networks either now known or developed in the future.

Moreover, the scope of the invention is intended to include implementation in networks using both adaptive and non-adaptive HARQ retransmission schemes, including HARQ retransmission schemes both now known and developed in the future.

The current invention is applicable to both the uplink and downlink scheduling for UTRAN LTE. Both uplink (UL) and downlink (DL) scheduling is managed by the Node-B, by sending the allocation in the DL. For UL scheduling, the allocation tells the UEs which resource blocks (RBs) they are allowed to transmit on. For DL scheduling, the allocation tells the UEs in which RBs they should receive data.

A resource block (RB) can be defined, for example, under the assumption of orthogonal frequency division multiple access (OFDMA) in the DL, and single carrier frequency division multiple access (SC-FDMA) in the uplink for UTRAN LTE. An RB then refers to a portion of the total available bandwidth. Such a definition of RBs makes it possible to multiplex users on the shared channel also in the frequency domain.

### BRIEF DESCRIPTION OF THE DRAWINGS

The drawings includes the following Figures, which are not necessarily drawn to scale:

FIG. 1a diagrams the basic architecture of a Universal Mobile Telecommunications System (UMTS) packet network, including a user equipment according to the present invention.

FIG. 1b diagrams a network according to long-term evolution, including a user equipment according to the present invention.

FIG. 2 shows a network element (NE) according to an embodiment of the present invention.

FIG. 3 is a flow chart showing a method according to an embodiment of the present invention.

FIG. 4 is a block diagram showing a system according to an embodiment of the present invention.

### DETAILED DESCRIPTION

An exemplary embodiment of the invention will now be described. The allocation for each scheduled user often comprises:
1. The user ID, which in 3GPP LTE is called radio link ID (RLID)
2. The modulation scheme
3. The transport block size
4. The allocated resource blocks, i.e. which frequency sub-carriers are allocated to the user
5. HARQ information, i.e. first transmission or retransmission, redundancy version of it is retransmissions, etc.
   All of this information is often required for first transmissions. However, for HARQ retransmissions, the allocation design can be further optimized.

If non-adaptive HARQ is used, then the allocated resource blocks and modulation scheme are limited to be the same for retransmissions as for the first transmission. Hence, the present invention optimizes the allocation for HARQ retransmissions, so that the resource blocks and modulation scheme are not included in the AT.

If adaptive HARQ is used, then the allocated resource blocks can be different for the HARQ retransmission as compared to the original first transmission. However, the modulation scheme is the same, so for this case the allocation design for HARQ retransmissions can be optimized by not including the modulation scheme in the AT, but still including the resource blocks. As the transport block used for the retransmission is the same as for the first transmission, this value need not be signaled either.

If a synchronous HARQ is used, then it is known exactly at which time instant the HARQ retransmission is going to be scheduled. For such cases, there is in principle no need for the allocation for HARQ retransmissions, if we assume non-adaptive HARQ with Chase combining (Chase combining is a special case of incremental redundancy). Correspondingly, if we assume a certain pre-determined retransmission scheme for HARQ, the UE can do blind or semi-blind estimation of the redundancy version used for the retransmissions.

Thus, according to this embodiment of the invention, a base station (i.e. Node B) initiates an allocation in order to schedule users for a shared channel, and includes less transmission information in the allocation for a scheduled HARQ retransmission than for a scheduled first transmission. The transmission information for a scheduled first transmission includes a modulation scheme, but the modulation scheme is not included in the allocation for a scheduled HARQ retransmission. In a further embodiment of this method, the allocation omits resource blocks if the HARQ retransmission is non-adaptive, but includes the resource blocks if the HARQ retransmission is adaptive. In yet a further embodiment of this method, the allocation information is not transmitted, if the scheduled HARQ retransmission is synchronous and is also non-adaptive with Chase combining.

The method just described can be implemented by a computer program product comprising a computer useable medium having computer readable program code embodied therein, the program product comprising program code for performing the method. Likewise that method can be implemented with software that is run using a general purpose or specific-use computer system, which also uses standard operating system software. The software is designed to drive the operation of the hardware of the system, and will be compatible with other system components and I/O controllers. This computer system includes a CPU processor comprising a single processing unit, multiple processing units capable of parallel operation, or alternatively the CPU can be distributed across one or more processing units in one or more locations, e.g., on a client and server. The computer system also includes a memory that may comprise any known type of data storage and/or transmission media, including magnetic media, optical media, random access memory (RAM), read-only memory (ROM), a data cache, a data object, etc. Moreover, similar to the CPU, the memory may reside at a single physical location, comprising one or more types of data storage, or be distributed across a plurality of physical systems in various forms.

The present invention can normally be implemented primarily at the NE. Moreover, the user equipment may be suitably adapted to cooperate with the NE functionality.

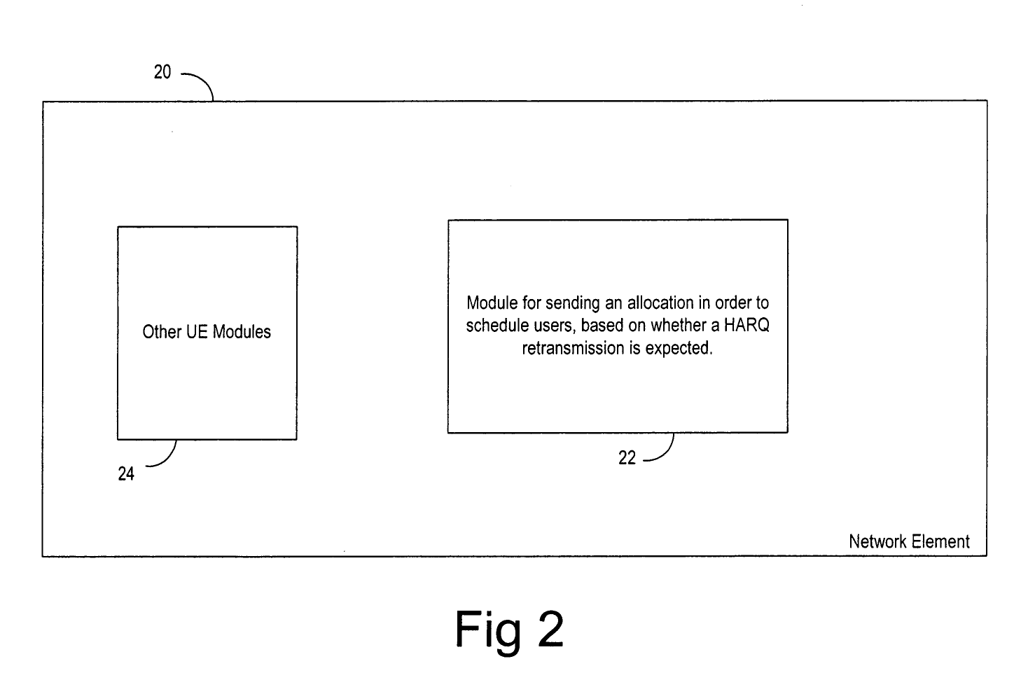

FIG. 2 shows, by way of example, an NE 20 having a module 22 for selectively sending the allocation to a user equipment, based on whether a HARQ retransmission is expected. The UE will receive a downsized allocation from the base station (Node B) if it is known that HARQ retransmissions will be scheduled. The module 22 may include one or more steps for determining when the HARQ retransmissions are scheduled.

By way of example, and consistent with that described herein, the functionality of the module 22 may be implemented using hardware, software, firmware, or a combination thereof, although the scope of the invention is not intended to be limited to any particular embodiment thereof. In a typical software implementation, the module 22 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the module 22 being stand alone modules, as shown, or in the combination with other circuitry for implementing another module in the NE.

The NE includes other modules 24 (or circuits, or devices) that do not form part of the underlying invention per se. The functionality of the other modules, circuits, devices that do not form part of the underlying invention are known in the art and are not described in detail herein. For example, the other modules 24 may include modules that form part of a typical base station, core network, radio network controller, or the like, which are known in the art and not described further herein.

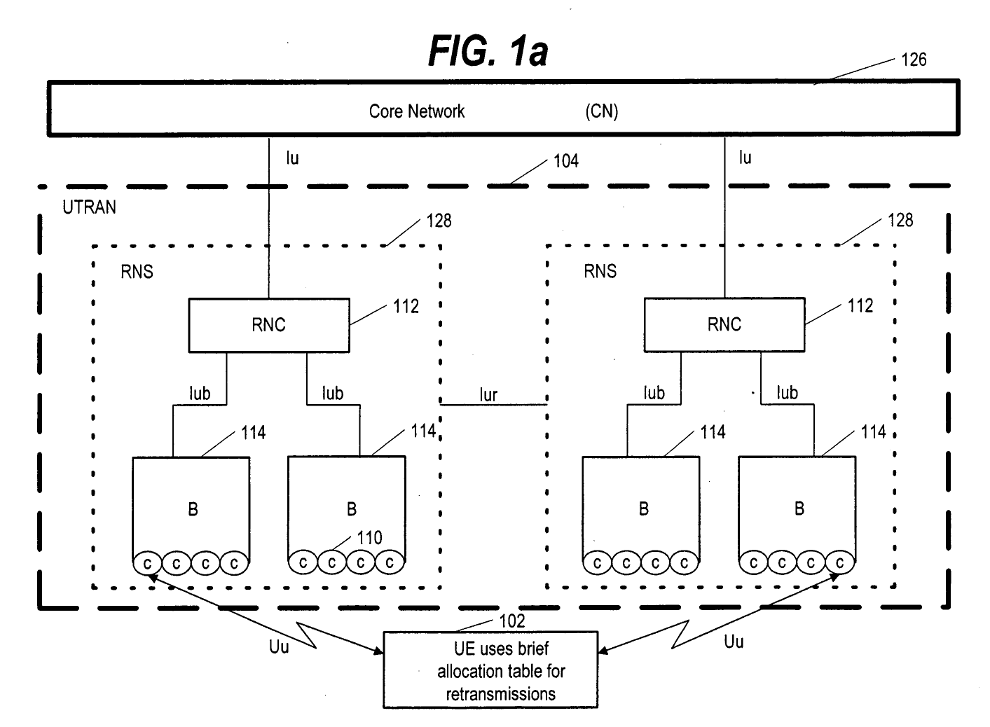

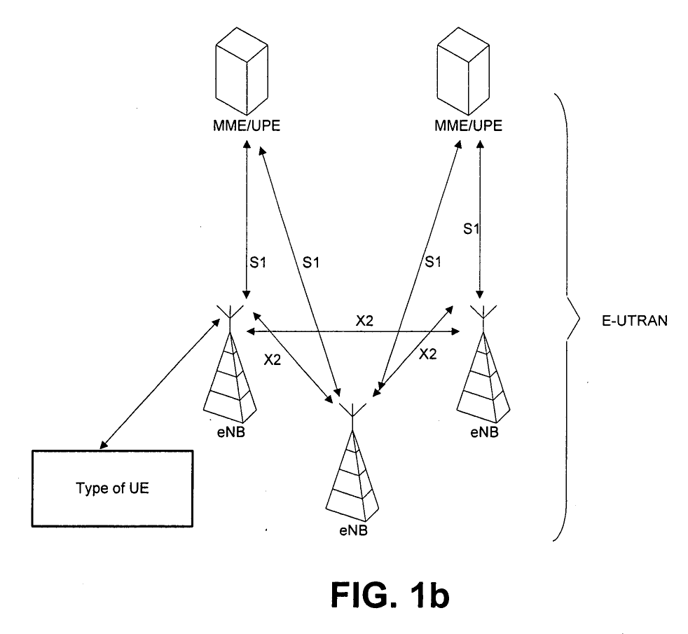

Embodiments of the present invention may include a user equipment (UE) having a suitable module either for receiving and processing the allocation from the base station, or for cooperating with the module 22 in the NE 20 of FIG. 2 for implementing the present invention in a network like that shown in FIG. 1a or 1b.

The present invention may also take the form of a chip or chipset for an NE in such a UMTS or other suitable network, which may include a number of integrated circuits designed to perform one or more related functions, such as that shown in FIG. 2. For example, one chip or chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such an NE, node, or device. One advantage of the present invention is that it can be used to reduce (optimize) the overhead for cases where HARQ retransmissions are used.

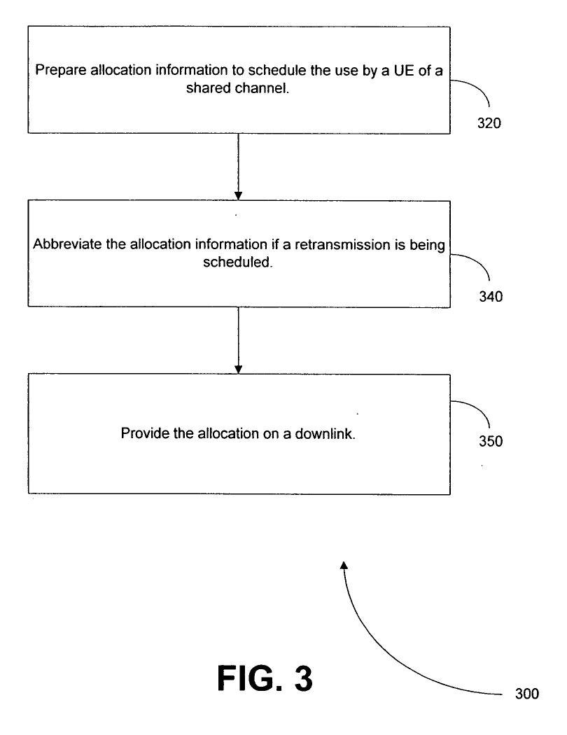

Referring now to FIG. 3, an embodiment of a method 300 according to the present invention is shown in the form of a brief flow chart. Allocation information is prepared 320 in order to schedule the use by a user equipment of a shared channel. The allocation information is abbreviated 340 if a retransmission is being scheduled, instead of an original transmission being scheduled. Then, the allocation information is provided 340 on a downlink.

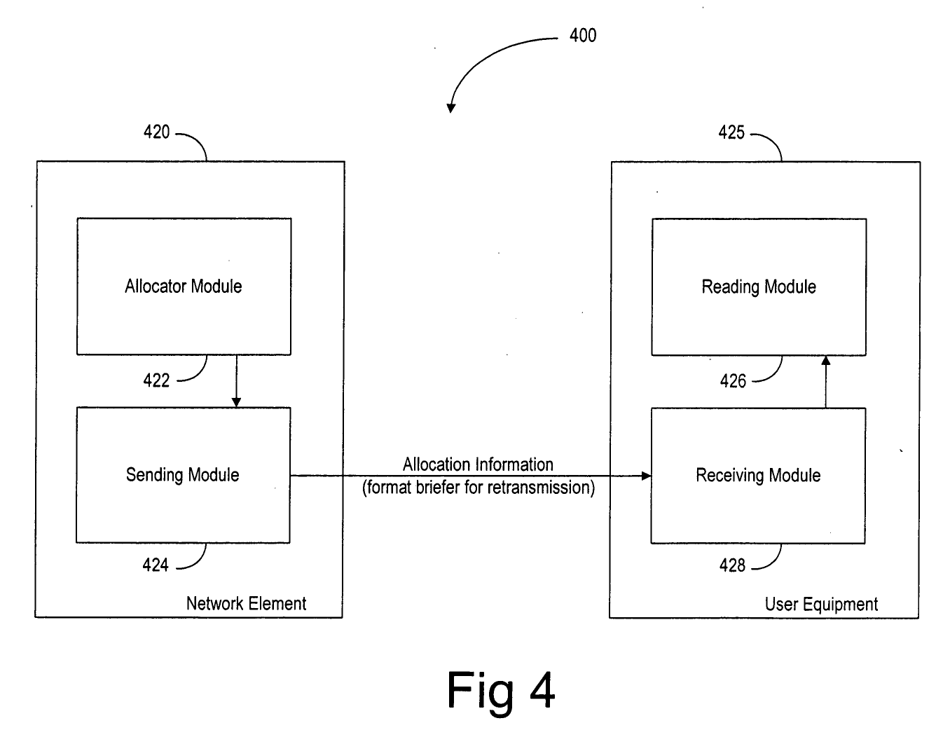

FIG. 4 illustrates (in simplified form) a system 400 for implementing an embodiment of this invention. The system includes a network element 420, and a user equipment 425. Within the network element, and allocator module 422 prepares the allocation information, which is then sent to the user equipment from a sending module 424. The allocation information will be abbreviated if a retransmission is being scheduled. At the user equipment, a receiving module 428 receives the allocation information, and then a reading module 426 reads the allocation information in order to schedule use of a shared uplink or downlink.

It is to be understood that all of the present figures, and the accompanying narrative discussions of best mode embodiments, do not purport to be completely rigorous treatments of the method, apparatus, network element, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein. Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense. It is also to be understood that the claims provided below are also illustrative, and do not exclude other embodiments of the invention, including but not limited to embodiments formed by changing the dependencies of the dependent claims.

What is claimed is:

1. A method comprising:
preparing allocation information to schedule at least one user equipment on a shared channel; and
providing the allocation information on a downlink,
wherein the allocation information is briefer if a retransmission is being scheduled instead of an initial transmission being scheduled.

2. The method of claim 1,
wherein the allocation information is contained in an allocation table which is carried on a downlink shared control channel, and
wherein the allocation information is for scheduling both uplink and downlink communication.

3. The method of claim 1,
wherein the briefer allocation information is abbreviated by excluding at least modulation scheme information, and
wherein the modulation scheme is substantially identical for the retransmission as for a corresponding preceding original transmission.

4. The method of claim 3,
wherein the briefer allocation information uses a format that also excludes allocated resource block information, if the retransmission is non-adaptive instead of adaptive, in which case an allocated resource block is substantially identical for the retransmission as for the corresponding preceding original transmission.

5. The method of claim 4,
wherein the method further comprises excluding all other information from the format, if the retransmission is synchronous and non-adaptive, with Chase combining.

6. The method of claim 1, wherein the allocation information describes which resource blocks to use for uplink transmission, and which resource blocks to use for downlink transmission.

7. The method of claim 6, wherein each of the resource blocks is a portion of total available bandwidth, using frequency division multiple access.

8. The method of claim 7, wherein the frequency division multiple access is orthogonal in the downlink, and single carrier in the uplink.

9. The method of claim 1, wherein the allocation information for both the original transmission and the retransmission at least includes a user identification, a transport block size, and hybrid automatic repeat request information.

10. A user equipment comprising:
a receiving module configured to receive allocation information on a downlink; and
a reading module configured to read the allocation information to schedule the user equipment on a shared channel,
wherein the allocation information is briefer if a retransmission is being scheduled instead of an initial transmission being scheduled.

11. The user equipment of claim 10,
wherein the allocation information is contained in an allocation table which is carried on a downlink shared control channel, and
wherein the allocation information is for scheduling both uplink and downlink communication.

12. The user equipment of claim 10,
wherein the briefer allocation information is abbreviated by excluding at least modulation scheme information, and
wherein the modulation scheme is substantially identical for the retransmission as for a corresponding preceding original transmission.

13. The user equipment of claim 12,
wherein the briefer allocation information uses a format that also excludes allocated resource block information, if the retransmission is non-adaptive instead of adaptive, in which case an allocated resource block is substantially identical for the retransmission as for the corresponding preceding original transmission.

14. A network element comprising:
an allocator module configured to prepare allocation information so as to schedule at least one user equipment on a shared channel; and
a sending module configured to provide the allocation information on a downlink,
wherein the allocation information is briefer if a retransmission is being scheduled instead of an initial transmission being scheduled.

15. The network element of claim 14,
wherein the allocation information is contained in an allocation table which is carried on a downlink shared control channel, and
wherein the allocation information is for scheduling both uplink and downlink communication.

16. The network element of claim 14,
wherein the briefer allocation information omits at least modulation scheme information, and
wherein the modulation scheme is substantially identical for the retransmission as for a corresponding preceding original transmission.

17. The network element of claim 16,
wherein the briefer allocation information is in a format that also omits allocated resource block information, if the retransmission is non-adaptive instead of adaptive, in which case an allocated resource block is substantially identical for the retransmission as for the corresponding preceding original transmission.

18. The network element of claim 17,
wherein all other information is omitted from the format, if the retransmission is synchronous and non-adaptive, with Chase combining.

19. The network element of claim 14, wherein the allocation information describes which resource blocks to use for uplink transmission, and which resource blocks to use for downlink transmission.

20. The network element of claim 19, wherein each of the resource blocks is a portion of total available bandwidth, using frequency division multiple access.

21. The network element of claim 20, wherein the frequency division multiple access is orthogonal in the downlink, and single carrier in the uplink.

22. The network element of claim 14, wherein the allocation information for both the original transmission and the retransmission at least includes a user identification, a transport block size, and hybrid automatic repeat request information.

23. A computer program product comprising a computer readable medium having executable code stored therein; the code, when executed by a processor, adapted to carry out functions comprising:
preparing allocation information to schedule at least one user equipment on a shared channel; and
providing the allocation information on a downlink,
wherein the allocation information is briefer if a retransmission is being scheduled instead of an initial transmission being scheduled.

24. The computer program product of claim 23,
wherein the allocation information is contained in an allocation table which is carried on a downlink shared control channel, and
wherein the allocation information is for scheduling both uplink and downlink communication.

25. The computer program product of claim 23,
wherein the briefer allocation information is abbreviated by excluding at least modulation scheme information, and
wherein the modulation scheme is substantially identical for the retransmission as for a corresponding preceding original transmission.

26. The computer program product of claim 25,
wherein the briefer allocation information uses a format that also excludes allocated resource block information, if the retransmission is non-adaptive instead of adaptive, in which case an allocated resource block is substantially identical for the retransmission as for the corresponding preceding original transmission.

27. A network element comprising:
means for preparing allocation information so as to schedule at least one user equipment on a shared channel; and
means for providing the allocation information on a downlink,
wherein the allocation information is briefer if a retransmission is being scheduled instead of an initial transmission being scheduled.

28. The network element of claim 27,
wherein the allocation information is contained in an allocation table which is carried on a downlink shared control channel, and
wherein the allocation information is for scheduling both uplink and downlink communication.

29. The network element of claim 27,
wherein the briefer allocation information omits at least modulation scheme information, and
wherein the modulation scheme is substantially identical for the retransmission as for a corresponding preceding original transmission.

30. The network element of claim 29,
wherein the briefer allocation information is in a format that also omits allocated resource block information, if the retransmission is non-adaptive instead of adaptive, in which case an allocated resource block is substantially identical for the retransmission as for the corresponding preceding original transmission.

31. A user equipment comprising:
means for receiving allocation information on a downlink; and
means for reading the allocation information to schedule the user equipment on a shared channel,
wherein the allocation information is briefer if a retransmission is being scheduled instead of an initial transmission being scheduled.

32. The user equipment of claim 31,
wherein the allocation information is contained in an allocation table which is carried on a downlink shared control channel, and
wherein the allocation information is for scheduling both uplink and downlink communication.

33. A system comprising:
a network element configured to prepare allocation information so as to schedule a user equipment on a shared channel; and
the user equipment, configured to receive the allocation information on a downlink,
wherein the allocation information is briefer if a retransmission is being scheduled instead of an initial transmission being scheduled.

34. The system of claim 33,
wherein the allocation information is contained in an allocation table which is carried on a downlink shared control channel, and
wherein the allocation information is for scheduling both uplink and downlink communication.

35. A chipset comprising:
circuitry configured to allocate information so as to schedule at least one user equipment on a shared channel; and
circuitry configured to provide the allocation information on a downlink,
wherein the allocation information is briefer if a retransmission is being scheduled instead of an initial transmission being scheduled.

36. The chipset of claim 35,
wherein the allocation information is contained in an allocation table which is provided on a downlink shared control channel, and
wherein the allocation information is arranged to schedule both uplink and downlink communication.
